(19) United States
(12) Patent Application Publication
(10) Pub. No.: US 2024/0216897 A1
(43) Pub. Date: Jul. 4, 2024

(54) PROCESS FOR PREPARING FLUID CATALYTIC CRACKING CATALYSTS, FLUID CATALYTIC CRACKING CATALYSTS AND USES THEREOF

(71) Applicant: PETROLEO BRASILEIRO S.A. - PETROBRAS, Rio de Janerio (BR)

(72) Inventors: Renato Necco Castro, Rio de Janerio (BR); Taina Valente, Rio de Janerio (BR); Jose Marcos Moreira Ferreira, Rio de Janerio (BR); Marco Antonio Santos De Abreu, Rio de Janerio (BR); Marlon Brando Bezerra De Almeida, Rio de Janerio (BR)

(21) Appl. No.: 18/399,511

(22) Filed: Dec. 28, 2023

(30) Foreign Application Priority Data
Dec. 29, 2022 (BR) 1020220270333

(51) Int. Cl. B01J 29/08; B01J 35/32; B01J 35/51; B01J 35/61; B01J 35/63; B01J 35/70; B01J 37/02; B01J 37/03; B01J 37/12; B01J 37/30; C10G 11/05; C10G 11/18

(52) U.S. Cl. CPC B01J 29/088; B01J 35/32; B01J 35/51; B01J 35/615; B01J 35/638; B01J 35/70; B01J 37/0236; B01J 37/033; B01J 37/038; B01J 37/12; B01J 37/30; C10G 11/05; C10G 11/18; B01J 2229/20; B01J 2229/37; B01J 2235/00; C10G 2300/202

(57) ABSTRACT

The present invention relates to a process for preparing fluid catalytic cracking (FCC) catalysts having porosity and accessibility controlled by the activity of water-soluble porogens. The catalyst produced can be used as an additive for fluid cracking, as additives for SOx and NOx reduction, as a combustion promoter and reduction of sulfur in cracked naphtha. It can also be used in hydrocracking, as a support for hydrotreating catalysts, catalytic pyrolysis of post-consumer polymers (rubber tires, plastic films, and so on) and pyrolysis of biomass.

### FIELD OF THE INVENTION

The present invention relates to the field of catalytic conversion for cracking a hydrocarbon feed, for example obtained from oil processing, and relates to a process for preparing fluid catalytic cracking (FCC) catalysts and a catalyst composition having porosity and accessibility controlled by the activity of water-soluble porogenic agents.

The catalysts thus produced can be used as a catalyst for fluid cracking, as an additive for fluid cracking, as additives for SOx and NOx reduction, as a combustion promoter and reduction of sulfur in cracked naphtha. They can also be used in hydrocracking, as a support for hydrotreating catalysts, catalytic pyrolysis of post-consumer polymers (rubber tires, plastic films, and so on) and pyrolysis of biomass.

### BACKGROUND OF THE INVENTION

Over the last three decades there has been an increased use of atmospheric distillation residues as part of the feed for fluid catalytic cracking units (FCCU). In addition to this fact, many FCCUs were subjected to modifications (REVAMPs) to operate using reactors with very low contact time between the catalyst and the feed (catalyst-oil). These two facts have created the need to develop catalysts exhibiting different characteristics as to pore volume distribution, mainly in the size range responsible for cracking the high molecular weight hydrocarbons present in abundance in atmospheric residue.

In the instance of processing feeds having high concentration of atmospheric residues, the micropores provided by zeolite Y, which is commonly used in FCC catalysts as an active ingredient, are not large enough to allow the diffusion of high molecular weight molecules into the interior of the structure where the acidic sites responsible for cracking reactions are located. Therefore, the pore distribution in the Silica-alumina matrix becomes even more important to allow access of reagents to the matrix acidic sites per se, as well as providing fast desorption of the products of cracking reactions.

Pore volume distribution of the fluid cracking catalyst is an extremely important property for its performance, mainly when the FCC process feed has a high level of atmospheric residue and, therefore, high molecular weight hydrocarbon molecules.

Many of the catalyst properties, such as activity, selectivity to high-value products, ease of rectification (removal of hydrocarbons adsorbed on the catalyst) and regeneration depend largely on its pore size distribution.

Such property of the cracking catalyst can be significantly modified by changing the composition ratio between zeolite Y and silica-alumina matrix. However, the best combination of ingredients to yield a pore distribution that is more suitable for cracking heavy hydrocarbons may not be the best combination to achieve catalyst selectivity for the highest yield of desirable products in the refinery. Therefore, simple manipulation of the catalyst formulation is not capable of providing the yield gain related to the better pore volume distribution, ensuring the best selectivity for the catalyst.

There exist in the literature methods to modify the porosity of inorganic oxides, which can be applied at different stages in the preparation of these oxides, such as: in the synthesis of precursor gels (by precipitation, crystallization and other methods), in the drying stage by different heat treatments and in the molding stage. However, these methods have not been proven effective in the manufacture of catalytic cracking catalysts, as this material is made up of a mixture of several inorganic oxides and the direct application of these methods does not provide the same benefits. The use of porogenic agents such as those described herein overcomes the aforementioned difficulties, as their use is effective in modifying the pore distribution in cracking catalysts and can be carried out in formulations specifically developed to meet different market demands. Furthermore, water-soluble chemicals are used, mixed with the catalyst precursor suspension which, when subjected to process conditions for the production of cracking catalysts are decomposed into volatile chemicals, leaving no residues that would require treatment to be removed from the catalyst. Moreover, the chosen porogen agent can be added at different stages of the zeolitic catalyst preparation without any negative effects on the final properties of the catalyst. In the proposed process, chemicals are introduced into the inorganic matrix prior to the drying stage and are fully removed (by heat treatment, chemical treatment or washing) at the end of the process, without altering the generated pore structure.

### STATE OF THE ART

It appears that the use of chemicals capable of changing the pore volume distribution of catalysts is widely used in industry, mainly to control the pore structure in the manufacture of supports for hydrotreating catalysts. Some of the agents most used for this purpose are carbon black and microcrystalline cellulose. Other agents that can be used are active charcoal, sugar, starch and organic polymers. For example:

Document U.S. Pat. No. 4,536,281 describes that porosity of a cracking catalyst can be significantly changed to the pore diameter range between 100 to 6000 Angstroms by adding carbon black composed basically of crosslinked primary particles. Documents WO 82/03571 and U.S. Pat. No. 4,356,113 also describe very similar processes using carbon black particles as a porogen agent. Documents PI 9704925-5 B1 and WO 02/100983 A2 deal with the process of preparing the precursor suspension of zeolitic catalyst for catalytic cracking, modified by the addition of a water-soluble carbohydrate-type compound as a porogen agent, for example, sucrose, maltose, cellobiose, lactose, glucose or fructose. In these documents, the porogen agent is added to the catalyst precursor solution formed by the mixture of inorganic oxide hydrosol, zeolites, aluminas, silicas, silica-aluminas and kaolin. However, the use of the above described materials as porogenic agents brings disadvantages such as the high cost of these compounds and the need to remove them from the formed structure through calcination or washing. Another way to increase porosity and accessibility of catalytic cracking catalysts is described in WO 02/098563 A1 (PI 0210773-4 A). This document describes a process for the production of catalysts having improved accessibility, which consists of combining the catalyst components in an aqueous medium with acids or bases such as HNO₃, HCl, NaOH, NH₄OH in a high shear mixing reactor prior to subjecting them to spray drying. Document U.S. Pat. No. 7,456,123 B2 deals with the process of preparing the zeolitic catalyst precursor suspension for catalytic cracking, modified by the addition of urea associated with a phosphate ion-containing compound to form the mixture. Moreover, this first mixture is mixed with an alkaline silicate solution prior to drying the suspension.

Document BR 112020014100-3 A2 refers to a process for preparing a catalyst and a particulate FCC catalyst comprising about 2 to about 50% by weight of one or more large-pore ultra-stabilized faujasite zeolites of high SiO₂/Al₂O₃ content or a USY containing rare earths, from 0 to about 50% by weight of one or more large pore, rare earth-modified faujasite zeolites, from 0 to about 30% by weight of small to medium pore size zeolites, from about 5 to about 45% by weight quasi-crystalline boehmite, from about 0 to about 35% by weight microcrystalline boehmite, from 0 to about 25% by weight of a first silica, from about 2 to about 30% by weight of a second silica, from about 0.1 to about 10% by weight of one or more rare earth components, which exhibits improved mesoporosity in the range of from 6 to 40 nm, the silica numbering corresponding to the order in which it is introduced in the preparation process. However, this document has considerable differences over the present invention, as it does not provide for the addition of alkali metal salts (or compounds) nor urea or carbamates, that is, it does not present gains in mesoporosity based on the addition of pore-regulating agents. Furthermore, the gain in mesoporosity is achieved by using more than one silica source in the catalyst particle. The first silica source is typically a low-sodium silica source and the second silica source is typically an ammonia-stabilized colloidal silica or a lower-sodium stabilized silica having a lower sodium content than the first silica source. In contrast, the present invention does not use any similar silica sources, but rather an inorganic oxide hydrosol as a source of silica binder.

Document PI 0511837-9 A relates to a mesoporous catalytic cracking catalyst, a process for producing such catalysts and a process using such catalysts in cracking operations. The mesoporous fluidized catalytic cracking catalyst is selective as it minimizes the production of coke and light gas. The catalyst comprises an amorphous porous matrix having pores ranging in diameter from 1 to 10 and ranging in diameter from 40 to 500 but being substantially free of pores ranging in diameter from 10 to 40. It appears that this document specifically mentions the use of urea as a porogenic agent. Also, it relates to the process of preparing the zeolitic catalyst precursor suspension for catalytic cracking, modified by the addition of urea associated with a phosphate ion-containing compound to form the mixture. This first mixture is mixed with an alkaline silicate solution prior to drying the suspension. In the present invention, despite the use of urea as a porogen agent, the addition of phosphate ions, addition of alkaline silicate solution and the addition of aluminum salts of mineral acids are not part of the scope of the invention and are not required to obtain a product having features suitable for fluid catalytic cracking, making it distinct from the aforementioned document.

U.S. Pat. No. 5,221,648 relates to a catalytic cracking catalyst for converting a hydrocarbon feedstock at elevated temperature in the substantial absence of hydrogen into lower average molecular weight and lower boiling point hydrocarbons useful as transportation fuels. The catalyst is a crystalline aluminosilicate zeolite composite at concentrations of up to about 80 percent based on the total weight of the catalyst in a mesoporous silica-alumina matrix. The matrix preferably consists of an alumina-modified silica solution and clay and is characterized by having a polymodal pore size distribution, as measured by mercury porosimetry, a first mode where at least 75 percent by weight, preferably about 80 percent by weight to 90 percent by weight of the pore volume measured between 45 Angstroms and 2000 Angstroms is in pores larger than 160 Angstroms in diameter and a second mode where up to about 20 percent of the pore diameters are larger than 100 Angstroms, but smaller than 160 Angstroms in diameter. These catalysts are highly active and selective in the production of olefins without a high coke content. The friction resistance of these catalysts, as measured by the Davison Index, is quite low, usually ranging from about 1 to about 8, more usually from about 1 to about 5 or less. However, such document does not make use of the addition of porogenic agents. It is a catalyst made of two distinct sources of silica. In the instant case, the first type of silica is a colloidal silica stabilized through ion exchange to reduce the sodium content and the second type is a silica prepared by the reaction between sodium silicate and an aluminum salt (sulfate, chloride or chlorohydrol). This method increases mesoporosity in a different manner than what is proposed by the present invention. Furthermore, the aforementioned document states that the final catalyst has as its main characteristic a very high mechanical strength, which is not seen in the present invention.

Document EP 1863588 B1 relates to a process for preparing a catalyst, the catalysts obtained by this process and the use thereof, for example, in fluid catalytic cracking (FCC). Said process comprises the steps of: (a) preparing a slurry comprising clay, zeolite, a sodium-free silica source, quasi-crystalline boehmite, and microcrystalline boehmite, provided that the slurry does not comprise peptized quasi-crystalline boehmite, (b) adding a monovalent acid to the slurry, (c) adjusting the pH of the slurry to a value above 3, and (d) shaping the slurry to form particles. This process results in attrition resistant catalysts with a good accessibility. However, this document does not provide for the addition of alkali metal salts (or compounds) nor urea or carbamates, that is, it does not present gains in mesoporosity based on the addition of pore-regulating agents. The silica source used in this document, i.e., lower sodium stabilized colloidal silica, also differs from the inorganic oxide hydrosol as the binder silica source used in the present patent application. It is also important to highlight that the order of addition of ingredients established in said document also differs from the present invention, with all the ingredients being present during the acidification step of non-peptized quasi-crystalline boehmite alumina. The main objective of this document is to achieve a better relationship between accessibility to active sites and mechanical strength of the particle through this order of addition.

### BRIEF DESCRIPTION OF THE INVENTION

The present invention aims to describe a process for preparing fluid catalytic cracking (FCC) catalysts and a catalyst composition having differentiated pore distribution, resulting in high porosity and activity. High porosity of the catalysts produced by the present invention is achieved by the use in their composition of chemicals capable of increasing mesoporosity of the catalyst in the pore diameter range between 10 to 1000 Angströms. Said chemicals can be of at least two different natures: a) salts made of volatile anions and/or cations: salts of weak acids and/or bases having a slightly alkaline hydrolysis pH and b) neutral species such as urea and carbamates.

The catalyst thus produced can be used as a catalyst for fluid cracking, as an additive for fluid cracking, as additives for SOx and NOx reduction, as a combustion promoter and reduction if sulfur in cracked naphtha. It can also be used in hydrocracking, as a support for hydrotreating catalysts, catalytic pyrolysis of post-consumer polymers (rubber tires, plastic films, and so on) and pyrolysis of biomass.

### BRIEF DESCRIPTION OF THE FIGURES

FIG. 1 depicts the relationship between Accessibility (AAI) and the Attrition Index (AI) for the catalysts prepared in Example 1.

FIG. 2 shows the pore volume distribution by pore diameter for the catalysts prepared in Example 1. wherein: Na₂CO₃ d1 is sample AM 3734 and Na₂CO₃ d2 is sample AM 3741 (see table 1)

FIG. 3 depicts the relationship between Accessibility (AAI) and the Attrition Index (AI) for the catalysts prepared in Example 2.

FIG. 4 shows the pore volume distribution by pore diameter for the catalysts prepared in Example 2.

### DETAILED DESCRIPTION OF THE INVENTION

The present invention relates to a process for preparing fluid catalytic cracking (FCC) catalysts having porosity and accessibility controlled by the activity of water-soluble porogens comprising the following steps:
(a) preparing a solid suspension containing: clay suspensions, microcrystalline and non-peptized quasicrystalline boehmite aluminas;
(b) adding (organic or inorganic) monovalent acid to the suspension;
(c) adding a suspension to the zeolite, such as Y-type zeolites, optionally exchanged with rare earth oxides and optionally ultrastabilized; ZSM-5 zeolite, phosphorus-activated ZSM-5 zeolite, beta zeolite, MCM-22 and MCM-36 zeolite, ITQs, SAPOs, ALPOs and mixtures thereof;
(d) mixing the resulting suspension with an inorganic oxide hydrosol in a fast mixing reactor;
(e) drying the catalyst precursor suspension by spray-drying (Spray-Dryer), resulting in zeolitic catalyst microspheres;
(f) washing and ion exchanging the obtained catalyst; and
(g) drying the final product using a drying column under hot air flow (Flash-Dryer).

The porogens used are added to the zeolitic catalyst in the form of an aqueous solution with a concentration between 5% and 50% by weight or directly as a solid and selected from the group comprising: (I) inorganic salts consisting of volatile anions and/or cations preferably including sodium and ammonium carbonate and bicarbonate and ammonium nitrate, acting through the release of CO₂ in an acidic medium or by heating, mechanically generating pores through the escape of gases while the catalyst is drying; (II) organic compounds that release volatile species in an acidic medium preferably including low molecular weight, water-soluble amides and carbamates that act as surface tension and viscosity modifiers, in addition to the possibility that CO₂ and NH₃ evolution mechanically contributes to pore formation. These agents can be added at any of the steps described in the preparation process, preferably after the addition of monovalent acid and more preferably as the last ingredient before drying the catalyst precursor suspension.

By means of the described process, there are provided catalysts for catalytic cracking comprising from 5 to 60% by weight of one or more zeolites, from 5 to 45% by weight of quasicrystalline boehmite (QCB), from 0 to 40% by weight of microcrystalline boehmite (MCB), more than 0 to 25% by weight of inorganic oxide hydrosol, 0.5 to 30% by weight of a porogen agent, and the balance being clay.

The catalysts chemical composition was obtained by X-ray Fluorescence (XRF). Textural properties were obtained using nitrogen adsorption isotherms at −196° C.

### Catalyst Characterization

The following tests were carried out to characterize the catalysts:

Specific Area (S.A.) of the catalyst was obtained through analysis of nitrogen adsorption isotherms at the temperature of liquid nitrogen, which results in the measurement of the catalyst specific area, a well-known technique used among specialists in the preparation of catalysts such as the BET method (from Brunauer, Emmet and Teller).

Micropore volume analysis is also obtained from the nitrogen adsorption isotherm and was based on the “t-plot” method (by Harkins & Jura) in the range of 3.3 to 5.4 Angstroms. Determination of mesopore volume was obtained using the BJH method (by Barrer, Joyner and Halenda) assuming the cylindrical pore model. The BJH method also allows an analysis of the pore volume distribution of the catalyst as a function of pore diameter from 20 Angstroms to pores with about 600 Angstroms.

Apparent bulk density (ABD) was measured using the ASTM 8212/213 methodology and corresponds to the measurement of the catalyst mass per unit volume after being placed in a fixed-, predetermined-volume cylinder beaker without compacting the bed.

The Attrition Index (AI) measures the mechanical strength of the catalyst particle by determining the percentage of fines (particles having an average diameter of less than 40 micrometers (mm)) generated after subjecting the catalyst sample to an air flow at a controlled flow rate of 7.07 l/min inside a vertical tube for 20 hours, promoting attrition between the particles and between the particles and the tube walls, trying to simulate the wearing conditions of an FCC industrial unit. Calculation of the attrition index (range of values between 0 and 30%) is obtained considering the percentage of fines collected at two time points (5 and 20 hours) according to the following expression:

AI=[(% fines at 5 h+4×% fines at 20 h)]/5; wherein the fines are particles having an average size below 40 microns in diameter. Therefore, the greater the particle strength, the lower the AI. Another methodology used to calculate the AI is using ASTM D 5757-00 analysis, which follows the same principle as previously described, but using a higher flow rate air flow, therefore generating more stringent conditions and reducing the fines collection time for 3 hours, obtaining results of less than 6%.

The accessibility index (AAI) brings an analogy with the mass transfer capacity of reactants through the catalyst pores and was measured by adding 1 gram (g) of catalyst sample to a vessel, preferably a beaker, that is kept under stirring and contains 50 g of a solution of vacuum gas oil (KVGO) in toluene at a concentration of 15 g/liter. The KVGO solution is then circulated between the beaker and a Perkin-Elmer Ultraviolet-Visible Spectrometer, wherein the KVGO solution concentration is continuously measured. Catalyst accessibility was quantified by the dimensionless Albemarle Accessibility Index (AAI), which varies between 0 and 35. KVGO concentration in the solution is plotted against the square root of the analysis time (between 5 and 6 minutes). AAI is defined as the initial slope of the graph and expressed by: AAI=−d(Cₜ/C₀)/d(t^{1/2})*100, where t is the analysis time in minutes; W₀ and Cₜ correspond to the weight concentration of KVGO at the beginning of the analysis and at any time t, respectively. The described catalysts have an accessibility index (AAI) of from 2 to 25.

### EXAMPLES OF THE INVENTION

### Example 1

The fluid cracking catalyst of this example was prepared by batch. In a 100 L-reactor, the following was added: 26 kg water; 10.9 kg sodium silicate and 5.4 kg inorganic acid for preparing the inorganic oxide hydrosol. After adjusting the pH with inorganic acid, 6.6 kg of kaolin suspension and 30 kg of quasicrystalline boehmite alumina suspension previously acidified with monoprotic acid were added. Then, 2.7 kg of microcrystalline boehmite alumina suspension and 20.8 kg of rare earth exchanged USY zeolite suspension were added.

The suspension dried in a spray dryer, at a 4 kg/min flow rate, drying air inlet temperature of 440° C. and outlet temperature of 140° C. The other catalyst preparations in this example were made by adding the porogen agent solution as the last ingredient according to Table 1.

TABLE 1
Identification of samples and porogen agents
used in Example 1.

| | | % by | | | |
|---|---|---|---|---|---|
| | | weight | | | |
| | | of | Added | | pH after |
| | | porogen | mass of | | addition |
| | | agent in | porogen | Initial pH | of |
| | Porogen | the | agent | of the | porogen |
| Sample | agent | solution | (kg) | suspension | agent |
| Reference | — | — | — | 3.40 | — |
| AM 3734 | Na₂CO₃ | 18% | 1.448 | 3.36 | 4.00 |
| AM 3741 | Na₂CO₃ | 18% | 2.122 | | |
| AM 3747 | NH₄HCO₃ | 15% | 3.135 | 3.40 | 4.03 |
| AM 3764 | Urea | 50% | 6.400 | 3.30 | 3.30 |
| AM 3765 | NaHCO₃ | 8% | 6.333 | 3.31 | 4.02 |
| AM 3766 | (NH₄)₂CO₃ | 16% | 2.090 | 3.39 | 4.00 |

After drying, the samples underwent an ion exchange process with ammonium sulfate to reduce the sodium content. The characterization results of the samples after the ion exchange process (final product) can be seen in Table 2.

TABLE 2
Chemical composition and properties of the catalysts prepared in Example 1.

| | Porogen | Al₂O₃ | Na₂O | RE₂O₃ | S.A. | MSA | MiPV | ABD | AI | AAI |
|---|---|---|---|---|---|---|---|---|---|---|
| Sample | agent | % w | % w | % w | m²/g | m²/g | ml/g | g/ml | (%) | — |
| Reference | — | 40.2 | 0.39 | 1.62 | 344 | 107 | 0.110 | 0.68 | 1.0 | 0.6 |
| AM 3734 | Na₂CO₃ | 39.2 | 0.46 | 1.75 | 359 | 124 | 0.109 | 0.69 | 4.1 | 3.6 |
| AM 3741 | Na₂CO₃ | 39.2 | 0.40 | 1.63 | 380 | 162 | 0.101 | 0.64 | 12.3 | 12.3 |
| AM 3747 | NH₄HCO₃ | 39.0 | 0.38 | 1.63 | 364 | 147 | 0.101 | 0.68 | 7.7 | 7.0 |
| AM 3764 | Urea | 39.3 | 0.40 | 1.64 | 379 | 159 | 0.102 | 0.67 | 3.3 | 4.0 |
| AM 3765 | NaHCO₃ | 39.0 | 0.38 | 1.63 | 400 | 169 | 0.107 | 0.69 | 8.7 | 8.9 |
| AM 3766 | (NH₄)₂CO₃ | 39.2 | 0.50 | 1.64 | 357 | 135 | 0.103 | 0.69 | 5.2 | 5.3 |

The catalysts chemical composition was obtained by X-ray Fluorescence (XRF). All samples have similar chemical composition, indicating that porogens were removed from the catalyst particle during the preparation process. Textural properties were obtained through nitrogen adsorption isotherms at −196° C., where the Specific Area (S.A.) was obtained by the BET method. The Micropore Volume (MiPV) and Mesopore Area (MSA) were obtained by the t-plot method. The greater MSA and S.A. values of the catalysts prepared with porogen agents shows the effectiveness of the agents used in this example.

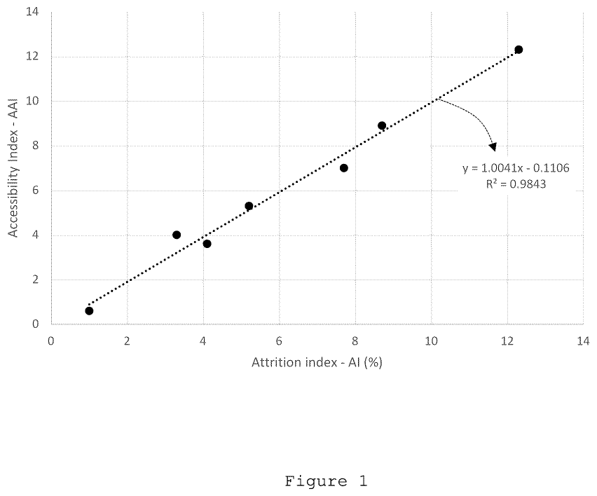

Bulk density (ABD) was measured using the ASTM 8212/213 methodology. The attrition index (AI) measures the mechanical resistance of the catalyst particle. The accessibility index (AAI) brings an analogy with the mass transfer capacity of reactants through the catalyst pores. The increased AAI using porogenic agents is accompanied by an increased AI (FIG. 1), but the AI did not exceed 15%, which is considered the maximum specification value with no occurrence of excessive loss in commercial cracking units.

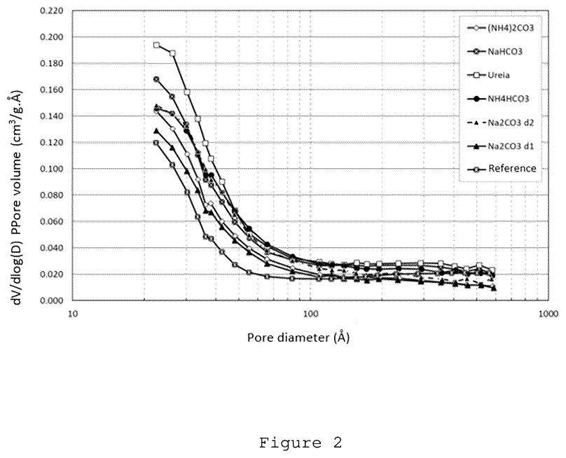

FIG. 2 illustrates the effect of porogen agents and their influence on the pore volume distribution of the fluid cracking zeolitic catalysts prepared in this example. Addition of all porogenic agents used in the preparations significantly modified the pore distribution as compared to the reference catalyst with no porogenic agents, especially in the size range of high molecular weight hydrocarbons (50 to 600 Angströms).

Table 3 exhibits the conversion values of the catalysts in this example after testing in a MAT (Micro Activity Test) laboratory unit at a constant catalyst/oil ratio (CTO). Before testing, the catalysts were deactivated in a fixed bed unit at 788° C. for 5 hours in the presence of steam. The vast majority of samples prepared with a porogen agent showed higher conversion than the reference sample, indicating the effectiveness of porogen agents and the great potential for increasing yields in commercial units.

TABLE 3
Conversion in a MAT unit at constant CTO.

| | | Conversion |
|---|---|---|
| | | (CTO 5), |
| Sample | Porogen agent | % w/w |
| Reference | Reference | 68.1 |
| AM 3734 | Na₂CO₃ pH = 4 | 76.6 |
| AM 3741 | Na₂CO₃ pH = 5 | 75.8 |
| AM 3747 | NH₄HCO₃ | 67.5 |
| AM 3764 | Urea | 72.1 |
| AM 3765 | NaHCO₃ | 72.5 |
| AM 3766 | (NH₄)₂CO₃ | 71.3 |

### Example 2

The fluid cracking catalyst in this example was prepared in a semi-continuous production process in a pilot-scale unit for preparing cracking catalysts. In this example, preparation of inorganic oxide hydrosol was carried out continuously and added to the further ingredients by pumping it into a rapid mixing reactor with high shear power. Therefore, the hydrosol at a weight concentration greater than in the batch process, which is a metastable component, is quickly mixed with the catalyst precursor suspension shortly before sending it for drying in a spray dryer. This process considerably increases the solids content of the catalyst suspension compared to the batch method, which reduces the production costs.

In a 90 L-reactor, the following was added: 1.4 kg of water; 6.4 kg of microcrystalline boehmite alumina suspension; 13.1 kg of rare earth exchanged USY zeolite suspension; 9.3 kg of quasicrystalline boehmite alumina suspension; 630 g of a 30% by weight solution of monoprotic acid and 2.2 kg of kaolin suspension. The suspension was sent for drying in a spray dryer, at a flow rate of 4 kg/min, drying air inlet temperature of 450° C. and outlet temperature of 135° C.

The other catalyst preparations in this example were carried out by adding the porogen agent solution as the last ingredient, except in sample C12-3670, where the porogen agent was added in a rapid mixing reactor. The porogen solution mass added can be seen in Table 4.

TABLE 4
Identification of samples and porogen agents
used in Example 2.

| | | % by | | | |
|---|---|---|---|---|---|
| | | weight | | | |
| | | of | | | |
| | | porogen | Added mass | | pH after |
| | | agent in | of porogen | Initial | addition |
| | Porogen | the | agent | pH of the | porogen |
| Sample | agent | solution | (kg) | suspension | agent |
| Reference | — | — | — | 2.70 | — |
| C12-3670 | NH₄HCO₃* | 20% | 2.0 | 2.70 | 5.35 |
| C12-3671 | NH₄HCO₃ | 20% | 2.0 | 2.70 | 3.77 |
| C12-3672 | NaHCO₃ | 10% | 4.0 | 2.70 | 3.61 |
| C12-3673 | (NH₄)₂CO₃ | 20% | 1.5 | 2.70 | 3.47 |
| C12-3674 | Na₂CO₃ | 20% | 1.5 | 2.70 | 3.97 |
| C12-3676 | Urea | 40% | 5.0 | 2.70 | 2.87 |

*Porogenic agent added in rapid mixing reactor

Samples resulting from drying, of an average particle size of 70 mm, underwent an ion exchange process with ammonium sulfate to reduce the sodium content. The characterization results of the samples after the ion exchange process (final product) can be seen in Table 5. The catalysts chemical composition was obtained by X-ray Fluorescence (XRF). All samples have similar chemical composition, indicating that porogens were removed during the preparation process.

TABLE 5
Chemical composition and properties of the catalysts prepared in Example 2

| | Porogen | Al₂O₃ | Na₂O | RE₂O₃ | S.A. | MSA | MiPV | ABD | AI | AAI |
|---|---|---|---|---|---|---|---|---|---|---|
| Sample | agent | % w | % w | % w | m²/g | m²/g | ml/g | g/ml | (%) | — |
| Reference | — | 43.4 | 0.36 | 2.65 | 308 | 111 | 0.092 | 0.79 | 2.0 | 1.1 |
| C12-3670 | NH₄HCO₃* | 42.6 | 0.35 | 2.67 | 379 | 192 | 0.087 | 0.64 | 11.5 | 10.5 |
| C12-3671 | NH₄HCO₃ | 42.6 | 0.28 | 2.58 | 368 | 164 | 0.095 | 0.70 | 7.0 | 3.7 |
| C12-3672 | NaHCO₃ | 41.5 | 0.31 | 2.66 | 316 | 99 | 0.102 | 0.72 | 2.9 | 3.0 |
| C12-3673 | (NH₄)₂CO₃ | 43.3 | 0.31 | 2.78 | 334 | 114 | 0.102 | 0.74 | 2.0 | 2.2 |
| C12-3674 | Na₂CO₃ | 43.9 | 0.35 | 2.76 | 373 | 180 | 0.089 | 0.65 | 8.3 | 9.4 |
| C12-3676 | Urea | 42.8 | 0.31 | 2.73 | 393 | 188 | 0.095 | 0.71 | 3.0 | 5.4 |

*Porogenic agent added in rapid mixing reactor

Textural properties were obtained through nitrogen adsorption isotherms at −196° C., where the specific area (S.A.) was obtained by the BET method. The Micropore Volume (MiPV) and Mesopore Area (MSA) were obtained by the t-plot method. The greater S.A. value for catalysts prepared with porogenic agents, mainly due to the increased mesopore area (MSA), shows the effectiveness of the agents used in this example. In the present example, samples C12-3672 and C12-3673 that were prepared, respectively, with the addition of sodium bicarbonate (NaHCO₃) and ammonium carbonate ((NH₄)₂CO₃) did not show the same gains in mesopore area as seen in Example 1. This effect is linked to the final pH of the suspension reached after addition of porogens to these samples. It is clear that to achieve the same results of gain in mesopore area it is necessary to dose the agent until the final pH of the suspension reaches values greater than those obtained in these samples.

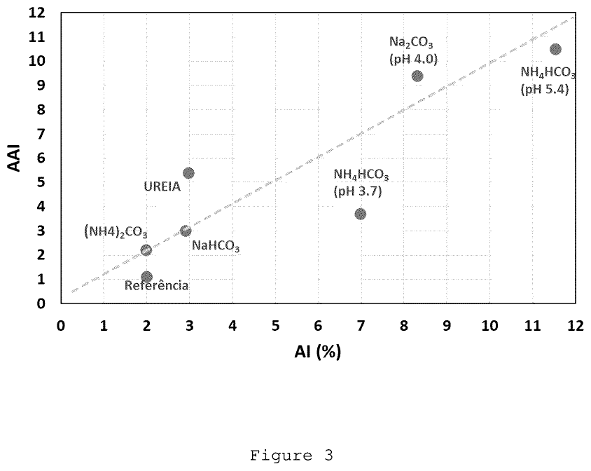

Bulk density (ABD) was measured using the ASTM B212/213 methodology. Table 5 clearly shows that addition of porogenic agents leads to lower ABD results, which led to an increased attrition index (AI) of the catalysts in relation to the reference sample. However, addition of porogenic agents did not cause the attrition index to exceed the value of 15% (see FIG. 3), which is considered the maximum specification value without the occurrence of excessive loss in commercial cracking units. Also in FIG. 3 it can be observed that the addition of porogenic agents leads to an increased accessibility of the catalyst, showing the increase in the mass transfer capacity of the reactants through the catalyst pores to reach the acidic sites responsible for cracking the process feed.

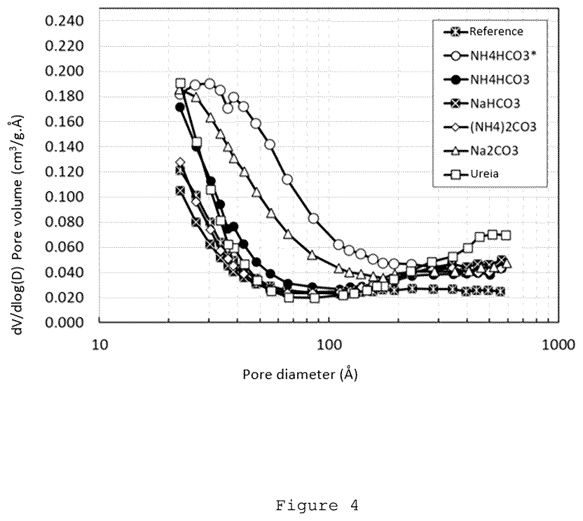

FIG. 4 illustrates the effect of porogen agents on the pore volume distribution of the fluid cracking zeolitic catalysts prepared in this example. In most cases, addition of porogens significantly modified the distribution, especially in the size range of high molecular weight hydrocarbons (50 to 600 Angströms). The cases where it was not possible to observe a very different pore volume distribution in relation to the reference catalyst are the same as those reported in the absence of a gain in mesopore area.

The reference sample and those where the porogen agent proved to be effective in this example were subjected to deactivation in a fixed bed unit at 788° C. for 5 hours in the presence of steam. After deactivation, the samples underwent a catalytic performance testing in a fluidized bed ACE (Advanced Cracking Evaluation) laboratory unit. Results of the performance evaluation can be seen in Table 6 and showed that all porogenic agents tested significantly outperformed the reference sample. The following can be highlighted:
Greater conversion at a constant catalyst/feed ratio (CTO);
Lower coke yield at constant conversion;
Higher yield of cracked naphtha at constant conversion and coke;
Greater yield of LCO (Light Cycle Oil), which is a stream used to increase diesel production in the refinery at constant conversion and coke;
Lower yield of decanted oil, bottoms, at constant conversion and coke.

TABLE 6
Results of catalytic evaluation in an ACE unit.

| Sample | Reference | C12-3670 | C12-3671 | C12-3674 | C12-3676 |
|---|---|---|---|---|---|
| Porogen agent | — | NH₄HCO₃* | NH₄HCO₃ | Na₂CO₃ | Urea |
| Conversion, % w/w @ | 69.3 | 73.0 | 73.4 | 74.5 | 73.0 |
| CTO = 5.5 | | | | | |
| Delta coke, % w/w @ | 1.09 | 1.19 | 1.22 | 1.30 | 1.30 |
| CTO = 5.5 | | | | | |
| Yields at a constant | | | | | |
| conversion = 74 % w/w | | | | | |
| Coke | 8.3 | 7.2 | 7.0 | 6.9 | 7.8 |
| Fuel gas | 3.05 | 3.10 | 3.09 | 3.20 | 3.21 |
| GLP | 17.1 | 16.9 | 16.7 | 16.8 | 17.1 |
| Cracked naphtha | 45.4 | 46.7 | 47.1 | 46.9 | 45.7 |
| LCO | 13.2 | 15.0 | 14.7 | 15.0 | 14.8 |
| Decanted oil (DO) | 12.8 | 11.0 | 11.3 | 11.0 | 11.2 |
| Constant coke | | | | | |
| yields = 7.0 % w/w | | | | | |
| Conversion, % w/w | 71.6 | 73.7 | 74.1 | 74.2 | 72.8 |
| Fuel gas | 2.90 | 3.06 | 3.10 | 3.21 | 3.09 |
| GLP | 16.1 | 16.7 | 16.8 | 16.9 | 16.3 |
| Cracked naphtha | 45.4 | 46.8 | 47.1 | 47.0 | 46.3 |
| LCO | 14.0 | 15.1 | 14.7 | 15.0 | 15.3 |
| Decanted oil (DO) | 14.4 | 11.1 | 11.2 | 10.9 | 11.9 |
| LCO/OD | 0.97 | 1.36 | 1.31 | 1.38 | 1.28 |

The conclusions obtained in Example 2 are quite similar to those found in Example 1, namely:
The porogenic agents used in this example were fully removed from the catalyst after carrying out all stages of the preparation process;
Addition of porogens leads to an increased mesopore area of the catalyst, which consequently causes an increase in the total specific area of the catalyst;
Addition of porogenic agents reduces the bulk density of the catalyst, increases accessibility and increases the attrition index, without reaching attrition index values higher than those acceptable for commercial application;
The pore volume distribution of the catalyst is substantially improved by the activity of the porogenic agents used in the example, making mass transfer for reactants and products of the cracking reaction easier;
pH values of the precursor suspension greater than 3.0, preferably greater than 4.0 have to be achieved for addition of the porogen agent to be effective, except for urea;
Performance of the cracking catalysts prepared with porogens in this example showed much better performance than the reference sample with no porogen agents;
Adding the porogen directly to the catalyst suspension or in a rapid mixing reactor leads to similar effects on catalyst performance.

### Advantages of the Invention

### Lower Costs/Yield

Currently, catalysts produced by Jade-Amethyst (JAM) technology with very high activity have low accessibility and unfavorable pore distribution for cracking high molecular weight molecules, negatively impacting the conversion of fluid catalytic cracking units (FCCU). Implementation of FCC catalyst manufacturing technology with porogens aims to solve this issue and can be used in any FCCU.

The porogenic agents described in the present invention are decomposed into volatile chemical species, leaving no residues that require treatment to be removed from the catalyst, which avoids additional production costs and increased price of the catalyst in addition to the raw material used. The use of porogenic agents aims to improve the diffusion of vaporized reagents from the cracking feed to the acidic sites of the zeolite, also favoring the diffusion of reaction products and, consequently, increasing the conversion of the FCC unit. Such increased conversion is directed towards three main streams of cracking products: LPG, cracked Naphtha and LCO, which is a stream used to increase Diesel production in the refinery. In other words, the anticipated gains are increased profitability at the refinery driven by the increase in the aforementioned streams and the distribution equation of dark products in the refinery.

1. A process for preparing fluid catalytic cracking catalysts comprising the following steps:
(a) preparing a solid suspension;
(b) adding monovalent acid to the solid suspension;
(c) adding the solid suspension to a zeolite;
(d) mixing the solid suspension and zeolite with an inorganic oxide hydrosol in a fast mixing reactor to create a catalyst precursor suspension;
(e) drying the catalyst precursor suspension by spray-drying, resulting in zeolitic catalyst microspheres;
(f) washing and ion exchanging the zeolitic catalyst microspheres; and
(g) drying the zeolitic catalyst microspheres using a drying column under hot air flow.

2. The process of claim 1, wherein the solid suspension comprises suspensions of clay, microcrystalline boehmite-type aluminas and non-peptized quasicrystalline aluminas.

3. The process of claim 1, wherein the zeolite is selected from the group consisting of Y-type zeolites, optionally exchanged with rare earth oxides and optionally ultra stabilized; ZSM-5 zeolite, phosphorus-activated ZSM-5 zeolite, Beta zeolite, MCM-22 and MCM-36 zeolite, ITQs, SAPOs, ALPOs and mixtures thereof.

4. The process of claim 1, wherein porogens are added to the zeolitic catalyst microspheres in the form of an aqueous solution at a concentration between 5% and 50% by weight or directly as a solid and selected from the group consisting of (I) inorganic salts consisting of volatile anions and/or cations, preferably sodium and ammonium carbonate and bicarbonate and ammonium nitrate; (II) organic compounds that release volatile species in an acidic environment, preferably low molecular weight amides and carbamates that are soluble in water.

5. The process of claim 4, wherein the porogens are preferably added after the addition of monovalent acid, and more preferably last prior to drying the catalyst precursor suspension.

6. Fluid catalytic cracking catalysts prepared according to the process as defined in claim 1, the fluid catalytic cracking catalysts comprise from 5 to 60% by weight of one or more zeolites, from 5 to 45% by weight of quasicrystalline boehmite (QCB), from 0 to 40% by weight of microcrystalline boehmite (MCB), more than 0 to 25% by weight of inorganic oxide hydrosol, from 0.5 to 30% by weight of porogen, and clay.

7. The fluid catalytic cracking catalysts of claim 6, wherein the fluid catalytic cracking catalysts have an increased pore volume in a pore diameter region between 20 to 600 Angstroms.

8. The fluid catalytic cracking catalysts of claim 6, wherein the fluid catalytic cracking catalysts have an attrition index (AI) of less than 6%.

9. The fluid catalytic cracking catalysts of claim 6, wherein the fluid catalytic cracking catalysts have an accessibility index (AAI) of 2 to 25.

10. Use of the fluid catalytic cracking catalysts as defined in claim 6, wherein the fluid catalytic cracking catalysts are used as an additive for fluid cracking as additives for reducing SOx and NOx, combustion promoter and reducing sulfur in cracked naphtha.

11. The use of claim 10, wherein the fluid catalytic cracking catalysts are also used for hydrocracking, support for hydrotreating catalysts, catalytic pyrolysis of post-consumer polymers and biomass pyrolysis.
